(19) United States
(12) Patent Application Publication
(10) Pub. No.: US 2008/0180413 A1
(43) Pub. Date: Jul. 31, 2008

(54) METHOD, SYSTEM, AND PROGRAM PRODUCT FOR CONTROLLING GRID LINES IN A USER INTERFACE

(76) Inventor: Brian G. Farn, Toronto (CA)

Correspondence Address: HOFFMAN WARNICK LLC, 75 STATE ST, 14TH FLOOR, ALBANY, NY, 12207, US

(21) Appl. No.: 11/668,073

(22) Filed: Jan. 29, 2007

(51) Int. Cl. G06F 3/01

(52) U.S. Cl. 345/184

(57) ABSTRACT

The present invention provides a solution for controlling gridlines. Specifically, the present invention provides a user interface control such as a slider or the like that allows a user to simultaneously control both the style and intensity of a displayed set of grid lines. In a typical embodiment, the user interface control has a plurality of settings that each are associated with a particular intensity value and style value. In response to a manipulation by a user, the style and intensity of the set of grid lines will be controlled/changed accordingly. The values are disposed within/among a plurality of ranges, one or more of which can overlap. Manipulation of the user interface control within any of the overlapping portion(s) can result in the set of grid lines being displayed with multiple styles.

### BACKGROUND OF THE INVENTION

1. Field of Invention

The present invention generally relates to user interface controls. Specifically, the present invention relates to the control of a set of grid lines displayed in a user interface.

2. Related Art

Many of today's software applications utilize visible grid lines to enhance a user's experience. For example, software development tools exist with the capability to allow software developers to define the content of displayable pages for character based 3270 or 5250 type terminal displays, otherwise known as green screens. Each displayable page includes of a set of characters arranged in a two-dimensional column/row grid configuration, the most common configuration being 80 columns wide by 24 rows high. A development tool may visually show the tool user the location of each cell in a grid of cells by displaying grid lines between each cell. Image editing tools also exist with the capability to display horizontal and vertical grid lines to aid in image alignment tasks.

Unfortunately, existing tools only provide a single grid style, a single grid intensity and a single user interface control which allows the tool user to control the visibility of grid lines. In view of the foregoing, there exists a need for a solution that solves at least one of the deficiencies of the related art.

### SUMMARY OF THE INVENTION

In general, the present invention provides a solution for controlling the appearance gridlines. Specifically, the present invention provides a user interface control such as a slider or the like that allows a user to control both the style and intensity of displayed set of grid lines. In a typical embodiment, the user interface control has a plurality of settings that each are associated with a particular intensity value and style value. In response to a manipulation by a user, the style and intensity of the set of grid lines will be simultaneously controlled/changed accordingly. The values are disposed within/among a plurality of ranges, one or more of which can overlap. Manipulation of the user interface control within any of the overlapping portion(s) can result in the set of grid lines being displayed with multiple styles and intensities.

A first aspect of the invention provides a method for controlling gridlines, comprising: providing a user interface control for controlling an intensity and a style of a set of grid lines displayed in a user interface; and controlling the intensity and the style of the set of grid lines in response to a manipulation of the user interface control.

A second aspect of the invention provides a system for controlling gridlines, comprising: a module for providing a user interface control for controlling an intensity and a style of a set of grid lines displayed in a user interface; and a module for controlling the intensity and the style of the set of grid lines in response to a manipulation of the user interface control.

A third aspect of the invention provides a program product stored on a computer readable medium for controlling gridlines, the computer readable medium comprising program code for causing a computer system to: provide a user interface control for controlling an intensity and a style of a set of grid lines displayed in a user interface; and controlling the intensity and the style of the set of grid lines in response to a manipulation of the user interface control.

A fourth aspect of the invention provides a method for deploying a system for controlling gridlines, comprising: providing a computer infrastructure being operable to: provide a user interface control for controlling an intensity and a style of a set of grid lines displayed in a user interface; and control the intensity and the style of the set of grid lines in response to a manipulation of the user interface control.

A fifth aspect of the invention provides computer software embodied in a propagated signal for controlling gridlines, the computer software comprising instructions for causing a computer system to: provide a user interface control for controlling an intensity and a style of a set of grid lines displayed in a user interface; and controlling the intensity and the style of the set of grid lines in response to a manipulation of the user interface control.

A sixth aspect of the invention provides a data processing system for controlling gridlines, comprising: a memory medium; a bus coupled to the memory medium; and a processor coupled to the bus, the memory medium comprising instructions that when executed by the processor cause the data processing system to: provide a user interface control for controlling an intensity and a style of a set of grid lines displayed in a user interface; and control the intensity and the style of the set of grid lines in response to a manipulation of the user interface control.

### BRIEF DESCRIPTION OF THE DRAWINGS

These and other features of this invention will be more readily understood from the following detailed description of the various aspects of the invention taken in conjunction with the accompanying drawings in which:

FIG. 1A depicts a linear intensity mapping function according to the present invention.

FIG. 1B depicts three grid intensity regions, each with its own linear intensity function according to the present invention

FIG. 2 shows an illustrative system for controlling gridlines according to the present invention.

FIG. 3 depicts an illustrative user interface control according to the present invention.

FIG. 4-14 show an illustrative user interface having a set of grid lines displayed with varying styles and/or intensities.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections:

I. General Description

II. Computerized Implementation

### I. General Description

As indicated above, the present invention provides a solution for controlling gridlines. Specifically, the present invention provides a user interface control such as a slider or the like that allows a user to control both the style and intensity of a displayed set of grid lines. In a typical embodiment, the user interface control has a plurality of settings that each are associated with a particular intensity value and style value. In response to a manipulation by a user, the style and intensity of the set of grid lines will be simultaneously controlled/changed accordingly. The values are disposed within/among a plurality of ranges, one or more of which can overlap. Manipulation of the user interface control within any of the overlapping portion(s) can result in the set of grid lines being displayed with multiple styles and intensities.

Among other things, this invention extends current capabilities by supporting multiple, simultaneously drawn grid line styles and intensities, and provides a method for a single user interface widget/control to control how grid lines are drawn. For example, this invention extends the control of basic grid lines used in today's tools in the following ways:

(1) Grid line styles
(a) Grid lines may be drawn using different grid line styles where each style is defined in terms of solidity (solid, or one of several non-solid or dotted styles).
(b) Each grid line style can be drawn in a range of intensity (brightness).
(c) Multiple grid line styles can be used simultaneously.

(2) Multiple cell indication
(a) A cell consists of a grouping of horizontal and vertical pixels. For instance, a cell could be 16 pixels wide by 24 pixels high.
(b) A multiple of cells may be indicated using a different grid line intensity. For instance, every tenth cell in a row and/or column may be distinguished from other cells by using a different grid line intensity. This aids the developer when determining the row/column number of a specific cell.

(3) Grid user interface control
(a) A single user interface control can be used to control when each grid line style is used and to control the grid line intensity of each style.

(4) Configuration
(a) A configuration user interface (not a part of this disclosure) can be created to allow tool users to define the following grid properties:
   (1) The set of grid line styles to be used.
   (2) When a grid line style is to be used.
   (3) Whether to highlight a multiple of cells.
   (4) Grid line intensity for each grid line style.

Under the present invention, a grid intensity range is defined as a set of numeric values that has a minimum (e.g. zero) and a predefined maximum, such as 100. A grid intensity user interface control is defined as a user interface control that allows a person to choose a specific value within the grid intensity range (a grid intensity value). Examples of user interface controls that can be used are sliders, scroll bars and spin buttons. A grid style is defined as the way a grid line is drawn, such as dotted, dashed or solid. However, grid style can refer to any type of formatting such as color, line thickness, etc. In addition, under the present invention, a grid line can be drawn at various line intensities. The intensity of a drawn grid line, its line intensity, can have a range of between zero and a predefined maximum, such as 255. The line intensity varies as a function of the grid intensity.

To this extent, a grid intensity region can be defined as having the following: (1) a grid style; (2) a range within the grid intensity range denoted by minimum and maximum grid intensity values; and/or (3) an intensity mapping function which maps from a grid intensity value to a line intensity value (the intensity at which a line is drawn). Either a linear or non-linear mapping function may be used. For example, a grid intensity region can have one or more of the following properties: (1) a dotted line style; (2) minimum and maximum grid intensity values which are the same as grid intensity range minimum and maximum values, such as from zero to 100 inclusive; and/or (3) a linear intensity mapping function which increases the line intensity value linearly as the grid intensity value increases.

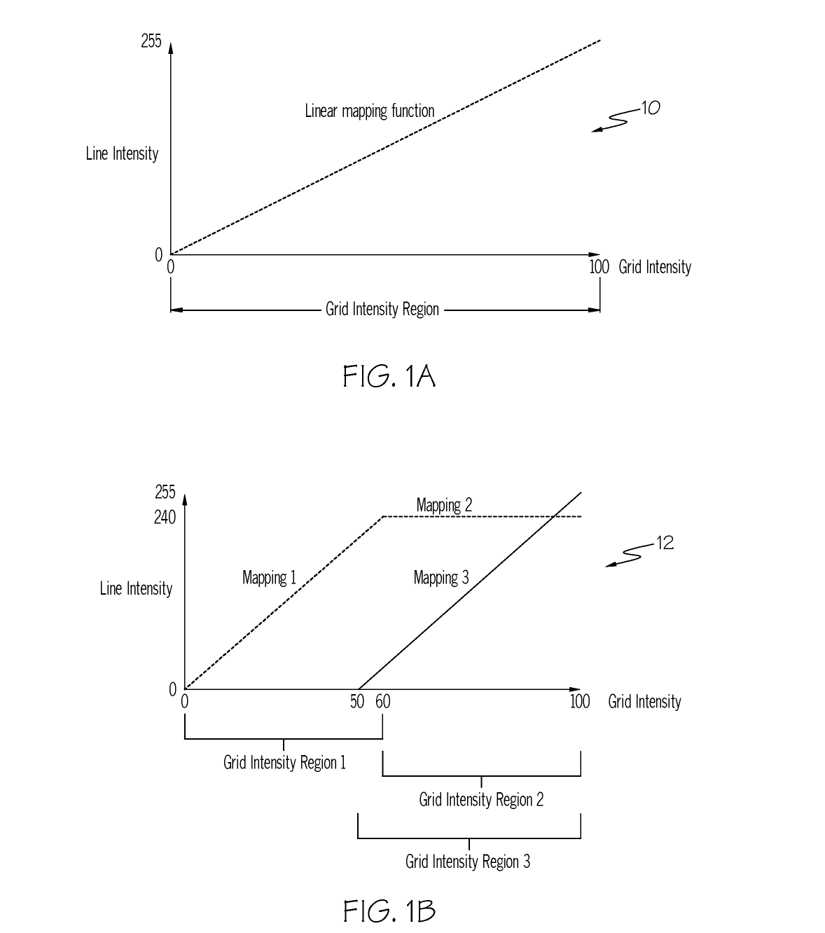

Referring now to FIG. 1A, an illustrative graph 10 of linear intensity mapping function is shown. In general, a linear intensity mapping function has the following characteristics: (1) a minimum grid intensity value; (2) a maximum grid intensity value; (3) a minimum line intensity value; and (4) a maximum line intensity value. The grid intensity region example shown in FIG. 1A has the following characteristic values:

| | | Grid | Grid | Line | Line |
|---|---|---|---|---|---|
| | | intensity | intensity | intensity | intensity |
| | Line style | minimum | maximum | minimum | maximum |
| Grid | dotted | 0 | 100 | 0 | 255 |
| intensity | | | | | |
| region | | | | | |

As indicated above, under the present invention, multiple grid intensity regions can be used together. The illustrative graph 12 shown in FIG. 1B has three grid intensity regions (e.g., 0-60, 60-100, and 50-100). The third grid intensity region (50-100) that has a solid line style overlaps the first two regions (0-60 and 60-100) that have a dotted line style. As a user increases the grid intensity value by manipulating a user interface control (shown in greater detail below) from zero to 60, a dotted grid line style is drawn and the drawn lines increase in intensity. The dotted grid line style continues to be drawn at grid intensity values greater than 60 with a single line intensity of 240. At grid intensities of 50 or more, a solid grid line style is also drawn with increasing intensity as the grid intensity increases.

These features are further shown in the following table:

| | | Grid | Grid | Line | Line |
|---|---|---|---|---|---|
| | | intensity | intensity | intensity | intensity |
| | Line style | minimum | maximum | minimum | maximum |
| Grid | dotted | 0 | 60 | 0 | 240 |
| intensity | | | | | |
| region 1 | | | | | |
| Grid | dotted | 60 | 100 | 240 | 240 |
| intensity | | | | | |
| region 2 | | | | | |
| Grid | solid | 50 | 100 | 0 | 255 |
| intensity | | | | | |
| region 3 | | | | | |

In addition, the present invention allows columns and/or rows to be highlighted (e.g., every nth column or row may be highlighted). For example, in order to indicate every tenth column in a grid, the line drawn after every tenth column is drawn highlighted. Along these lines, one or more of the following properties can additionally be defined for a grid intensity region: (1) a column highlight period—specifies the number of columns between each highlighted column; (2) a row highlight period—specifies the number of rows between each highlighted row; and/or (3) a highlight intensity factor—a positive real number, when multiplied by the intensity determined by the intensity mapping function for a value in the grid intensity region, results in a highlighted line intensity value.

The table below shows characteristic values for three grid intensity regions with highlight intensity factors:

| | | | Grid | Line | Line | Highlight |
|---|---|---|---|---|---|---|
| | | Grid Intensity | Intensity | Intensity | Intensity | Intensity |
| | Line Style | Minimum | maximum | Minimum | Maximum | Factor |
| Grid | dotted | 0 | 60 | 0 | 120 | 4.0 |
| intensity | | | | | | |
| region 1 | | | | | | |
| Grid | dotted | 60 | 100 | 240 | 240 | 4.0 |
| intensity | | | | | | |
| region 2 | | | | | | |
| Grid | solid | 50 | 100 | 0 | 255 | 2.5 |
| intensity | | | | | | |
| region 3 | | | | | | |

In general, the present invention implements the following method for drawing such grid lines. Specifically, a user specifies a grid intensity, for instance by using a user interface control such as a slider, or scroll bar. Depending on the value of the grid intensity, lines are drawn using the set of either predefined, or user defined grid intensity regions. The following method can be employed:

(1) For all grid lines to be drawn, whether they are horizontal or vertical,
(A) For each grid intensity region, if the grid intensity value falls within the grid intensity region's grid intensity minimum value and grid intensity maximum value, then
   (1) Given the grid intensity value, use the grid intensity region's mapping function to compute the line intensity.
   (2) If the line number being drawn is a multiple of either the row or column highlight period, then a highlighted line needs to be drawn. Multiply the line intensity value by the highlight intensity factor to obtain a new line intensity value.
   (3) Draw the line using the grid intensity region's line style and computed line intensity value limited to the maximum line intensity value.

### II. Computerized Implementation

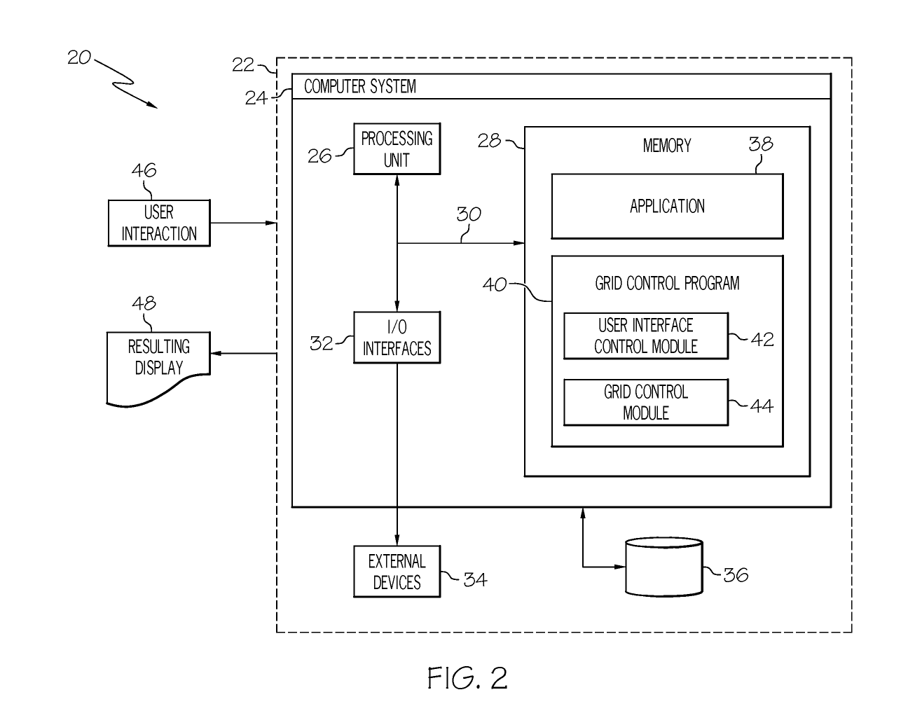

Referring now to FIG. 2, a more detailed diagram of a computerized implementation 20 of the present invention is shown. This implementation is capable of carrying out all of the features/functions described above. As depicted, implementation 20 includes computer system 24 deployed within a computer infrastructure 22. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets—based protocol, and an Internet service provider could be used to establish connectivity to the Internet. Still yet, computer infrastructure 22 is intended to demonstrate that some or all of the components of implementation 20 could be deployed, managed, serviced, etc. by a service provider who offers to implement, deploy, and/or perform the functions of the present invention for others.

As shown, computer system 24 includes a processing unit 26, a memory 28, a bus 30, and input/output (I/O) interfaces 32. Further, computer system 24 is shown in communication with external I/O devices/resources 34 and storage system 36. In general, processing unit 26 executes computer program code, such as application 38 and grid control program 40, which are stored in memory 28 and/or storage system 36. While executing computer program code, processing unit 26 can read and/or write data to/from memory 28, storage system 36, and/or I/O interfaces 32. Bus 30 provides a communication link between each of the components in computer system 24. External devices 34 can comprise any devices (e.g., keyboard, pointing device, display, etc.) that enable a user to interact with computer system 24 and/or any devices (e.g., network card, modem, etc.) that enable computer system 24 to communicate with one or more other computing devices.

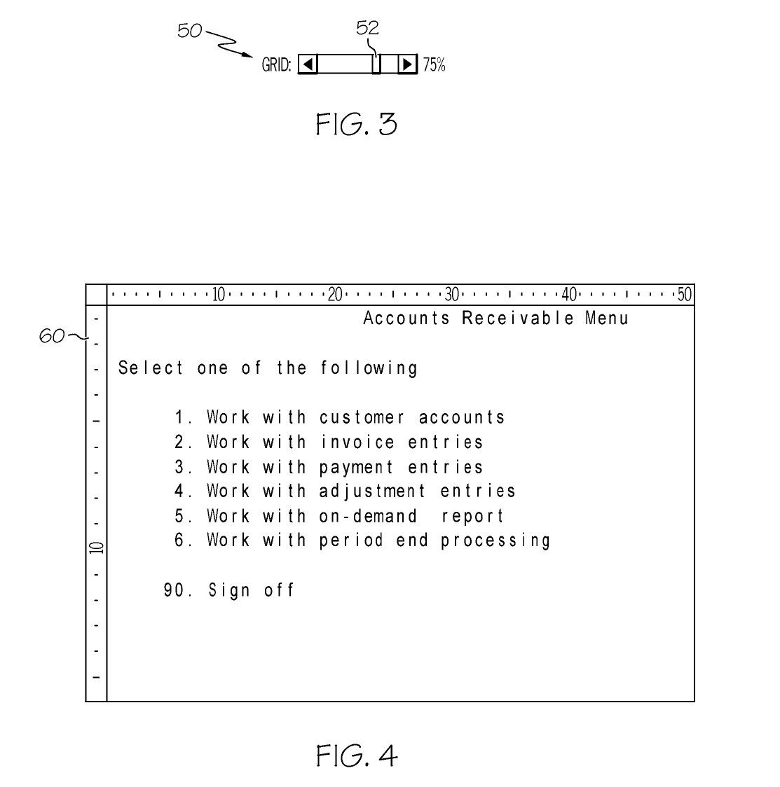

Computer infrastructure 22 is only illustrative of various types of computer infrastructures for implementing the invention. For example, in one embodiment, computer infrastructure 22 comprises two or more computing devices (e.g., a server cluster) that communicate over a network to perform the process(es) of the invention. Moreover, computer system 24 is only representative of various possible computer systems that can include numerous combinations of hardware. To this extent, in other embodiments, computer system 24 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 26 may comprise a single processing unit, or be distributed across one or more processing units in one or more locations, e.g., on a client and server. Similarly, memory 28 and/or storage system 36 can comprise any combination of various types of data storage and/or transmission media that reside at one or more physical locations. Further, I/O interfaces 32 can comprise any system for exchanging information with one or more external device 36. Still further, it is understood that one or more additional components (e.g., system software, math co-processing unit, etc.) not shown in FIG. 3 can be included in computer system 24. However, if computer system 24 comprises a handheld device or the like, it is understood that one or more external devices 36 (e.g., a display) and/or storage system 36 could be contained within computer system 24, not externally as shown.

Storage system 36 can be any type of system (e.g., a database) capable of providing storage for information under the present invention. To this extent, storage system 36 could include one or more storage devices, such as a magnetic disk drive or an optical disk drive. In another embodiment, storage system 36 includes data distributed across, for example, a local area network (LAN), wide area network (WAN) or a storage area network (SAN) (not shown). In addition, although not shown, additional components, such as cache memory, communication systems, system software, etc., may be incorporated into computer system 24. It should be understood computer system could be any combination of hardware and/or software. It is shown as such to illustrate the functions as described herein.

Shown in memory 28 of computer system 24 are application 38 and grid control program 40, the latter of which facilitates the functions as described herein. Application 38 can be any software program that is capable of displaying a user interface with grid lines. Examples include software development programs, spreadsheet programs, etc. As depicted, grid control program 40 includes user interface control module 42, and grid control module 44. It should be understood that this configuration of functionality is intended to be illustrative only, and that identical or similar functionality could be provided with a different configuration of systems.

In any event, when application 38 renders a user interface with a set (e.g., at least one) of gridlines, user interface control module 42 will render and display a user interface control that allows for user-controlled formatting of the set of gridlines. In a typical embodiment, the user interface control is a single control that allows both the style (e.g., solid or dashed) and intensity (e.g., brightness) of set of gridlines to be user controlled simultaneously. It should be understood, however, that the user interface control could allow other formatting features to be controlled such as highlighting, color, etc.

Referring now to FIG. 3, an illustrative user interface control 50 as provided by user interface control module 42 (FIG. 2) is shown. In this embodiment, user interface control 50 comprises a slider 52 than can be manipulated by a user to control the style and intensity of the set of gridlines. Specifically, user interactions/manipulations 46 (FIG. 2) with user interface control 50 will be received and processed by grid control module 44 (FIG. 2), which can then communicate corresponding instructions to application 38 to cause resulting display 48 (FIG. 2).

In a typical embodiment, user interface control 50 includes a plurality of positions, each of which is mapped to a particular style value and intensity value (as well as a value of any other formatting options desired). Based on the position of slider 52, a particular style value and intensity value will be “selected”. Along these lines, the values and positions can be disposed/arranged into a plurality of regions, one or more of which can optionally overlap. For example, region 1 could exist from 0-40, region 2 could exist from 30-60, and region could exist from 50-100. To this extent, if a user brings slider 52 to a rest within two overlapping regions, multiple styles can be caused. For example, if the user brought slider 52 to resting position “A” within two overlapping regions, the set of gridlines could be displayed with intensity “W” and “X” corresponding to the intensity values at resting position “A”, as well as with styles “Y and Z” (e.g., dashed and solid lines) corresponding to the style values at resting position “A.”

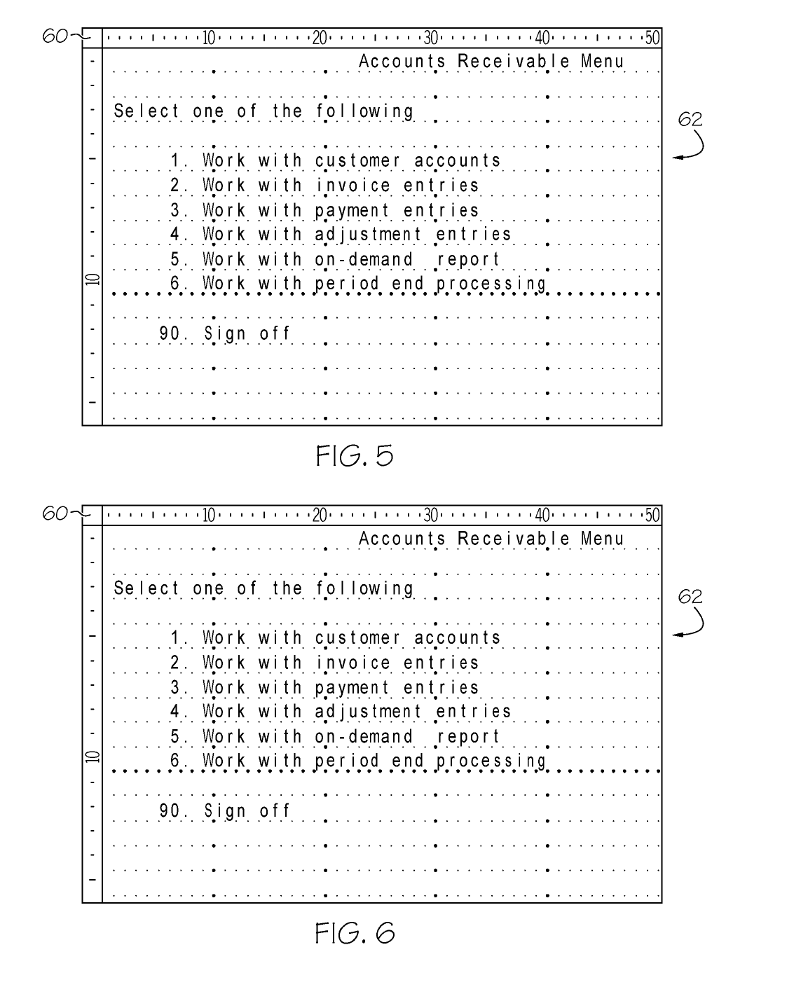

Referring to FIG. 4, a user interface 60 having gridlines with an intensity and style value of zero (referred to for clarity as position zero) is shown. Because the value is zero, the gridlines are not displayed. FIGS. 5-14 show a progression of intensities and styles, as slider 52 of user interface control 50 (FIG. 3) is slid horizontally along a hypothetical scale of zero (FIG. 4) to 100 (FIG. 14) in increments of ten. As the increments increase, the gridlines become more intense, and transition from variations of a dotted line style, to variations of a dashed line style, to a solid line style. Specifically, the progression can be described as follows:

FIG. 5, vertical and horizontal gridlines 62 having an intensity and style value of 10.

FIG. 6, vertical and horizontal gridlines 62 having an intensity and style value of 20.

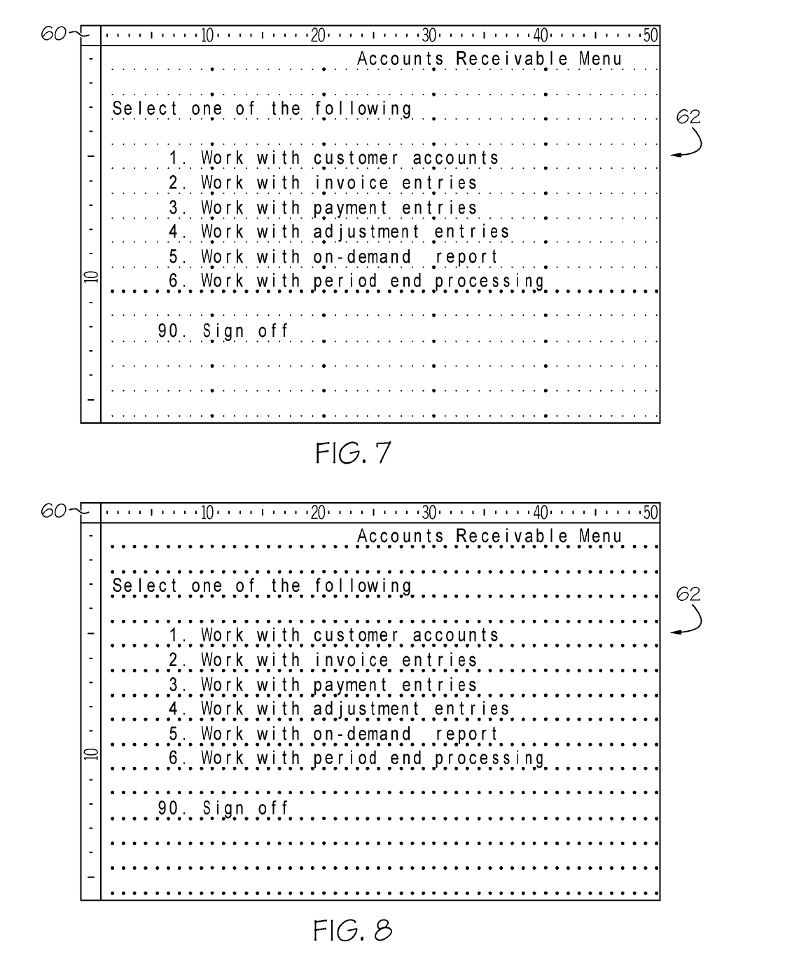

FIG. 7, vertical and horizontal gridlines 62 having an intensity and style value of 30.

FIG. 8, vertical and horizontal gridlines 62 having an intensity and style value of 40.

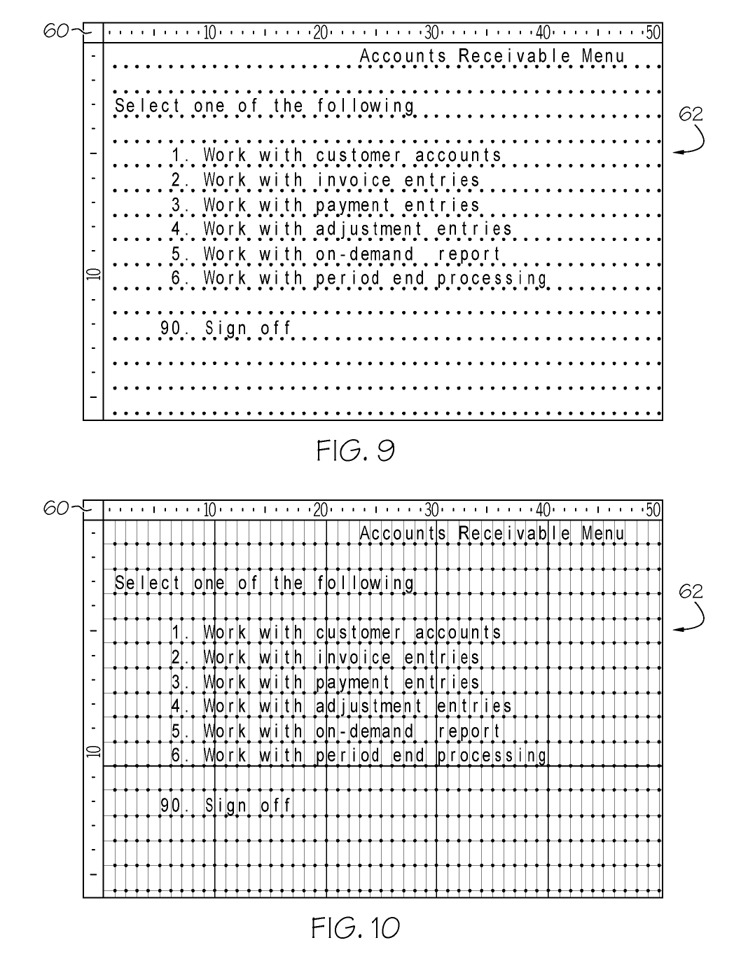

FIG. 9, vertical and horizontal gridlines 62 having an intensity and style value of 50.

FIG. 10, vertical and horizontal gridlines 62 having an intensity and style value of 60.

FIG. 11, vertical and horizontal gridlines 62 having an intensity and style value of 70.

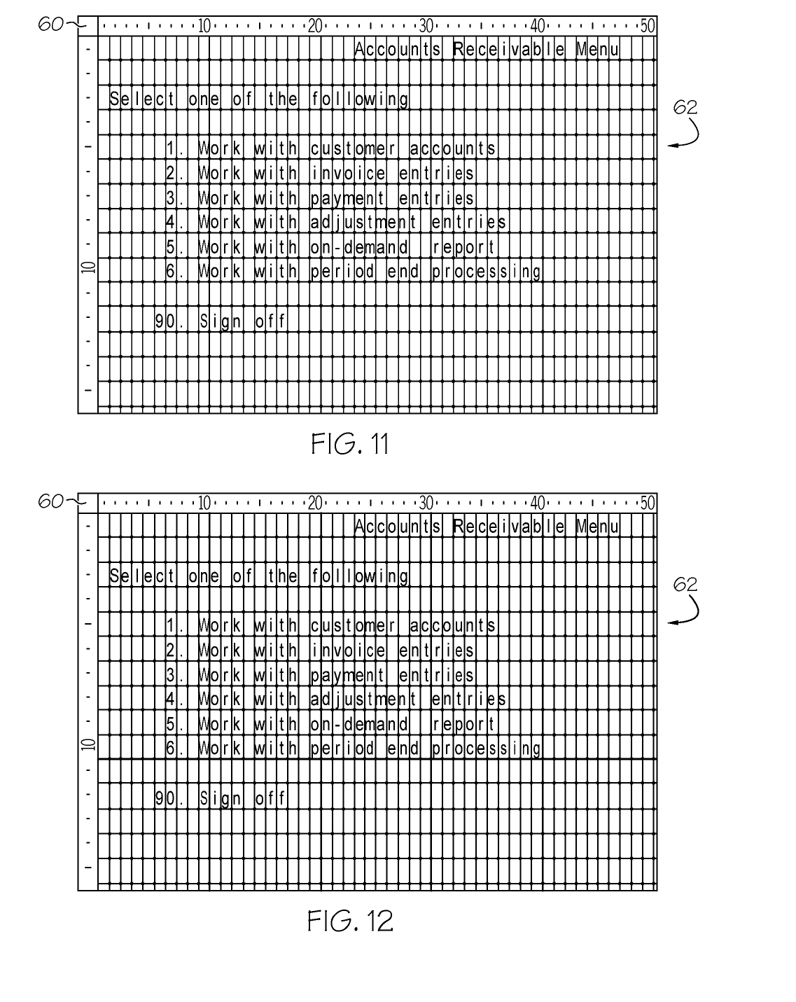

FIG. 12, vertical and horizontal gridlines 62 having an intensity and style value of 80.

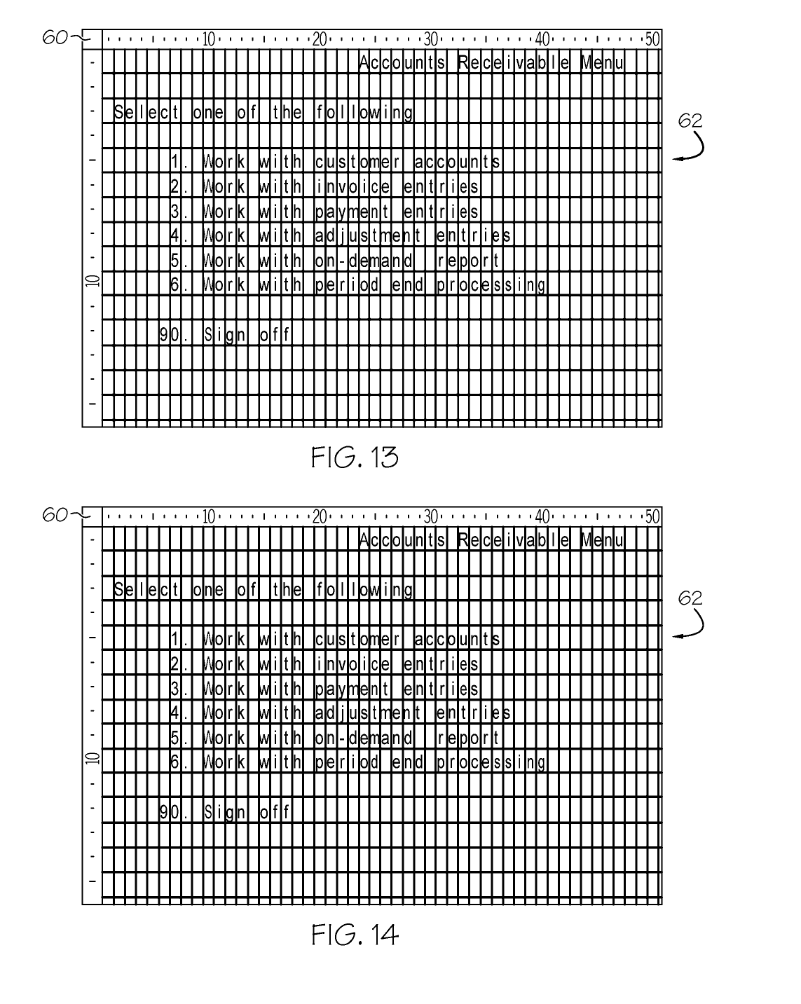

FIG. 13, vertical and horizontal gridlines 62 having an intensity and style value of 90.

FIG. 14, vertical and horizontal gridlines 62 having an intensity and style value of 100.

While shown and described herein as a method and system for controlling gridlines, it is understood that the invention further provides various alternative embodiments. For example, in one embodiment, the invention provides a computer-readable/useable medium that includes computer program code to enable a computer infrastructure to control gridlines. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 3) and/or storage system 36 (FIG. 3) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to control gridlines. In this case, the service provider can create, maintain, support, etc., a computer infrastructure, such as computer infrastructure 22 (FIG. 3) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for controlling gridlines. In this case, a computer infrastructure, such as computer infrastructure 22 (FIG. 2), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 24 (FIG. 2), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for controlling gridlines, comprising:
providing a user interface control for controlling an intensity and a style of a set of grid lines displayed in a user interface; and
controlling the intensity and the style of the set of grid lines in response to a manipulation of the user interface control.

2. The method of claim 1, the user interface control comprising a slider.

3. The method of claim 1, the style being selected from a group consisting of a broken grid line and a solid grid line.

4. The method of claim 1, the user interface control having a plurality of settings each of which is associated with a particular intensity value and a particular style value for the set of grid lines.

5. The method claim 4, the intensity values and the style values being disposed within a plurality of regions having overlapping portions, wherein a manipulation of the user interface control within one of the overlapping portions results in the set of grid lines being displayed with multiple styles.

6. The method of claim 1, the user interface control being further for controlling a highlighting of the set of grid lines.

7. The method of claim 1, the user interface control being further for controlling a color of the set of grid lines.

8. A system for controlling gridlines, comprising:
a module for providing a user interface control for controlling an intensity and a style of a set of grid lines displayed in the user interface; and
a module for controlling the intensity and the style of the set of grid lines in response to a manipulation of a user interface control.

9. The system of claim 8, the user interface control comprising a slider.

10. The system of claim 8, the user interface control having a plurality of settings each of which is associated with a particular intensity value and a particular style value for the set of grid lines.

11. The system claim 10, the intensity values and the style values being disposed within a plurality of regions having overlapping portions, wherein a manipulation of the user interface control within one of the overlapping portions results in the set of grid lines being displayed with multiple styles.

12. The system of claim 8, the style being selected from a group consisting of a broken grid line and a solid grid line.

13. The system of claim 10, the user interface control being further for controlling a color of the set of grid lines.

14. A program product stored on a computer readable medium for controlling gridlines, the computer readable medium comprising program code for causing a computer system to:
provide a user interface control for controlling an intensity and a style of a set of grid lines displayed in a user interface; and
controlling the intensity and the style of the set of grid lines in response to a manipulation of the user interface control.

15. The program product of claim 14, the user interface control comprising a slider.

16. The program product of claim 14, the user interface control having a plurality of settings each of which is associated with a particular intensity value and a particular style value for the set of grid lines.

17. The program product claim 16, the intensity values and the style values being disposed within a plurality of regions having overlapping portions, wherein a manipulation of the user interface control within one of the overlapping portions results in the set of grid lines being displayed with multiple styles.

18. The program product of claim 14, the style being selected from a group consisting of a broken grid line and a solid grid line.

19. The program product of claim 14, the user interface control being further for controlling a color of the set of grid lines.

20. A method for deploying a system for controlling gridlines, comprising:
providing a computer infrastructure being operable to:
provide a user interface control for controlling an intensity and a style of a set of grid lines displayed in a user interface; and
control the intensity and the style of the set of grid lines in response to a manipulation of the user interface control.
